(19) United States
(12) Patent Application Publication
(10) Pub. No.: US 2018/0066349 A1
(43) Pub. Date: Mar. 8, 2018

(54) METHOD FOR COATING A CYLINDER OF AN INTERNAL COMBUSTION ENGINE, AND CYLINDER FOR AN INTERNAL COMBUSTION ENGINE

(71) Applicant: Dr. Ing. h.c. F. Porsche Aktiengesellschaft, Stuttgart (DE)

(72) Inventor: Holger Klumpp, Moensheim (DE)

(21) Appl. No.: 15/695,097

(22) Filed: Sep. 5, 2017

(30) Foreign Application Priority Data
Sep. 8, 2016 (DE) 10 2016 116 815.7

(51) Int. Cl. C23C 4/134

(52) U.S. Cl. CPC C23C 4/134; F16J 10/04

(57) ABSTRACT

A method is provided for coating a cylinder of an internal combustion engine. The cylinder (1) has a cylinder lining surface section (4) with a piston running surface (5) that faces an interior space (3) of the cylinder (1) and along which a piston of the internal combustion engine (2) can be moved. The cylinder (1) also has at least one further surface (13, 14) that adjoins the interior space (3). The further surface (13, 14) may be a bearing section surface (13) for mounting a crankshaft of the internal combustion engine (2), and a run-out section surface (14) between the bearing section (6) and the cylinder lining surface section (4). The method includes forming a defined structure on the further surface (13; 14) and then spraying a coating on the piston running surface (5).

### CROSS REFERENCE TO RELATED APPLICATION

This application claims priority under 35 USC 119 to German Patent Appl. No. 10 2016 116 815.7 filed on Sep. 8, 2016, the entire disclosure of which is incorporated herein by reference.

### BACKGROUND

### Field of the Invention

The invention relates to a method for coating a cylinder of an internal combustion engine and to a cylinder for an internal combustion engine.

### Description of the Related Art

Cylinders of internal combustion engines are coated with a plasma spray to reduce wear caused by the oscillating movement of the piston in the cylinder.

EP 2 112 359 B1 discloses a cylinder with a piston running surface that is roughened with grooves or a spiral profile. The roughened structure has undercuts that result in an increase of an adhesive surface area and an improved adhesion for a coating of the cylinder.

EP 1 334 268 B1 discloses a cylinder with a piston running surface that has a thread-like structure that comprises two undulating shapes for improved adhesion of the coating.

EP 1 225 324 B1 discloses a cylinder for an internal combustion engine where the piston running surface has a coating consisting of an alloy. The piston running surface is roughened to have obliquely running teeth for improved adhesion of the coating.

However, particles of the coating material reflect during the coating operation and cause undefined embedding of the particles of the coating material occurs. The particles are reflected on surfaces that are configured in the cylinder of what is known as a honing run-out and bearing pedestals. These reflections lead to an inhomogeneous layer configuration caused by embedding of the reflected particles. This inhomogeneous coating leads in a further machining process or finishing process, such as honing of the cylinder, to ruptures and surface damage. As a result, the cylinder becomes unserviceable and can no longer be used.

It is an object of the invention to provide an improved method for coating a cylinder of an internal combustion engine. It is a further object of the invention to specify an improved cylinder for an internal combustion engine.

### SUMMARY

The invention relates to a method for coating a cylinder of an internal combustion engine. The cylinder may be in a crankcase of the internal combustion engine and may have a cylinder lining surface section with a piston running surface that is configured to face an interior space of the cylinder and along which a piston of the internal combustion engine can be moved. The cylinder may have further surfaces that adjoin the interior space. In particular, the cylinder has a bearing section surface of a bearing section that is provided for mounting a crankshaft of the internal combustion engine, and a run-out section surface of a run-out section that is between the bearing section and the running surface section. The further surface may face the interior space and may receive a defined structure in a first step, and the coating may take place by spraying the piston running surface in a second step. The advantage of the method of the invention is that the further surfaces of the cylinder that are not configured as a piston running surface receive a defined structure that is configured for a defined reflection of particles that are produced during an application of the coating. Thus, a substantially improved cylinder surface can be achieved in the region of the piston running surface. A reject rate is reduced and therefore production costs can be lowered substantially. The further surface may be the bearing section surface and/or a run-out section surface of the run-out section. The run-out surface may adjoin the piston running surface directly, and is therefore in direct contact with the latter. The bearing section surface serves for reflection, since it is transverse, usually perpendicular, to the piston running surface.

The coating may be a thermally resistant and mechanically resistant plasma coating.

An extraction of reflected particles takes place in a step that follows the second step or happens virtually at the same time. The extraction of the reflected particles leads to an ensured elimination of the reflected particles.

The defined structure may be removed in a further step that follows the second step or next step. After the coating has taken place, the defined structure on the further surface, in particular on the bearing section surface and/or the run-out surface, no longer has a function and can be removed to avoid a possible stress concentration that might otherwise be produced in a manner that is dependent on the defined structure. A further advantage is achieved in improved reworking of the cylinder, since the defined structure can be ruled out as a disruptive factor during reworking.

The removal of the coating that is applied on the further surface can take place at the same time as the removal of the applied defined structure. Thus, a cost saving is achieved by reducing the number of method steps.

The defined structure may be produced with the aid of a spindle process, a circular machining operation or a helical machining operation.

The defined structure may be produced by a tooth-shaped structure. A side surface of the tooth lies at an angle to the spraying jet. Thus, the teeth direct the particles striking thereon in a defined direction into the interior space of the cylinder, and thus in a direction that faces away from the piston running surface. The particles then can be removed simply, for example, by extraction. The defined structure may have an angle between two adjacent teeth with a value of between 0° and 90°.

The invention also relates to a cylinder for an internal combustion engine. The cylinder has a cylinder lining surface section with a piston running surface that is configured to face an interior space of the cylinder and along which a piston of the internal combustion engine can be moved. The cylinder has further surfaces that adjoin the interior space, in particular a bearing section surface of a bearing section that is provided for mounting a crankshaft of the internal combustion engine, and a run-out section surface of a run-out section that is between the bearing section and the cylinder lining surface section. The cylinder has a defined structure at least temporarily. A high quality coated piston running surface can be achieved by the at least temporarily defined structure. This reduces wear of the piston running surface and therefore leads to an increase in the service life of the cylinder.

Further advantages, features and details of the invention result from the following detailed description and the drawings. The features and combinations of features mentioned in the preceding text and the features and combinations of features mentioned in the following text and/or shown in the figure can be used in the specified combination, in other combinations or on their own, without departing from the scope of the invention.

### BRIEF DESCRIPTION OF THE DRAWINGS

FIG. 1 is a diagrammatic illustration of a cylinder of an internal combustion engine during a method for coating in accordance with the prior art.

FIG. 2 is a diagrammatic illustration of a cylinder according to the invention of an internal combustion engine during a method according to the invention for coating.

FIG. 3 is a detailed view III of the cylinder of FIG. 2.

FIG. 4 is a plan view of a crankcase with the cylinder according to the invention.

FIG. 5 is a cross-sectional view taken along line V-V of FIG. 4.

FIG. 6 is a detailed view VI of the cylinder of FIG. 4.

FIG. 7 is a detailed view VII of the cylinder of FIG. 4.

FIG. 8 is a perspective view of the crankcase of FIG. 5.

### DETAILED DESCRIPTION

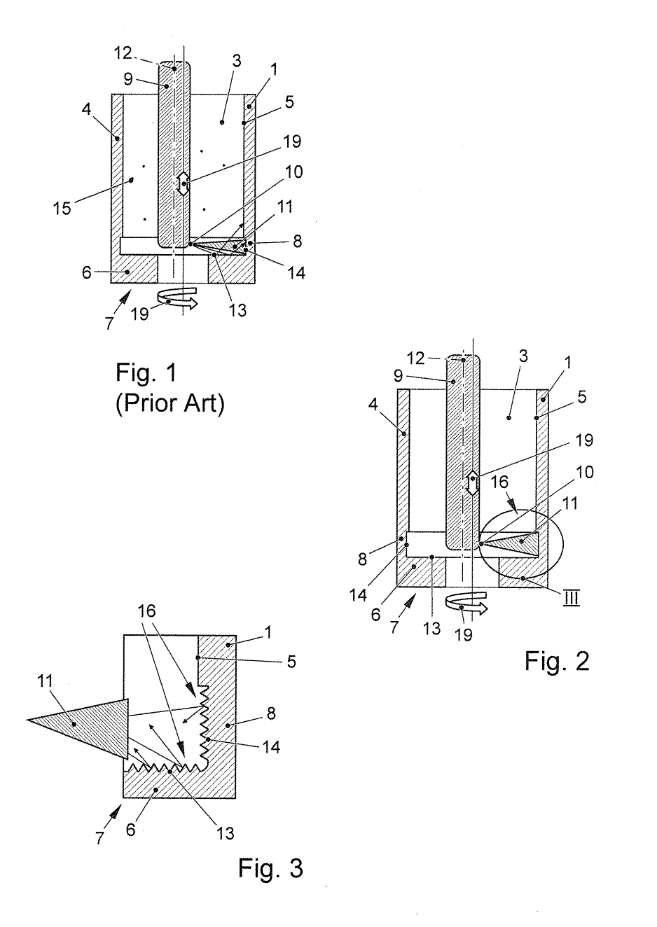

FIG. 1 is a diagrammatic illustration of a cylinder 1 of an internal combustion engine 2 during a method for coating in accordance with the prior art.

The cylinder 1 is hollow and has an interior space 3, in which a piston oscillates during operation of the internal combustion engine 2. A coating is applied in a region of a cylinder lining surface section 4 of the cylinder 1 on a piston running surface 5 that faces the interior space 3 to reduce wear between the cylinder 1 and the piston. The cylinder lining surface section 4 is the section of the cylinder 1 that is in contact with the piston or its piston rings during operation.

The cylinder 1 is in a crankcase 7 and comprises a bearing section surface 13 of a bearing section 6 of the crankcase 7. The bearing section 6 is provided for mounting a crankshaft (not shown in greater detail) of the internal combustion engine 2, and a run-out section 8 which is configured between the bearing section 6 and the cylinder lining surface section 4.

A plasma coating in the form of a spray coating is applied on the specially prepared piston running surface 5. The special preparation of the piston running surface 5 is to achieve improved adhesion of the coating on the piston running surface 5.

The method for coating is carried out by way a lance 9 that has an opening 10 for accommodating a spray jet 11 of coating material. The lance 9 rotates about its lance axis 12 and moves axial along the lance axis 12 while coating the cylinder 1, as indicated by the movement arrows 19.

In accordance with the prior art, particles 15 of the coating reflect and accumulate in an undefined and uncontrolled manner on the piston running surface 5 in the region on the bearing section surface 13 of the bearing section 6 that faces the interior space 3, and on a run-out section surface 14 of the run-out section 8 that faces the interior space 3.

FIG. 2 is a diagrammatic illustration of a cylinder 1 of the internal combustion engine 2 according to the invention and during a method according to the invention. The bearing section surface 13 and the run-out section surface 14 have a defined structure 16 to achieve a controlled reflection of the particles 15 that strike the bearing section surface 13 and/or run-out section surface 14. The defined structure 16 reflects the reflected particles 15 in a targeted manner into the interior space 3 where they are extracted.

This means that the method according to the invention has the configuration of the defined structure 16 on the bearing section surface 13 and the run-out section surface 14 in a first step. The coating which is a plasma coating in the present exemplary embodiment is applied, in particular, to the piston running surface 5 in a second step of the method according to the invention. That is to say, in other words, spraying of the piston running surface 5 takes place. During the coating or directly following it, the extraction of the reflected particles 15 takes place, of the plasma particles in the present exemplary embodiment.

On account of the spray jet 11, the further surfaces 13, 14 which are configured so as to face the interior space 3, that is to say, in particular, the bearing section surface 13 and the run-out section surface 14, are likewise sprayed with the coating material, that is to say with plasma. That is to say, said further surfaces 13, 14 likewise have a coating.

After the coating and the extraction, the bearing section surface 13 and the run-out section surface 14 are machined further, the coating which has likewise accumulated there being removed. The defined structure 16 is likewise removed at the same time as said removal.

The defined structure 16 might likewise also be removed following the removal of the accumulated coating.

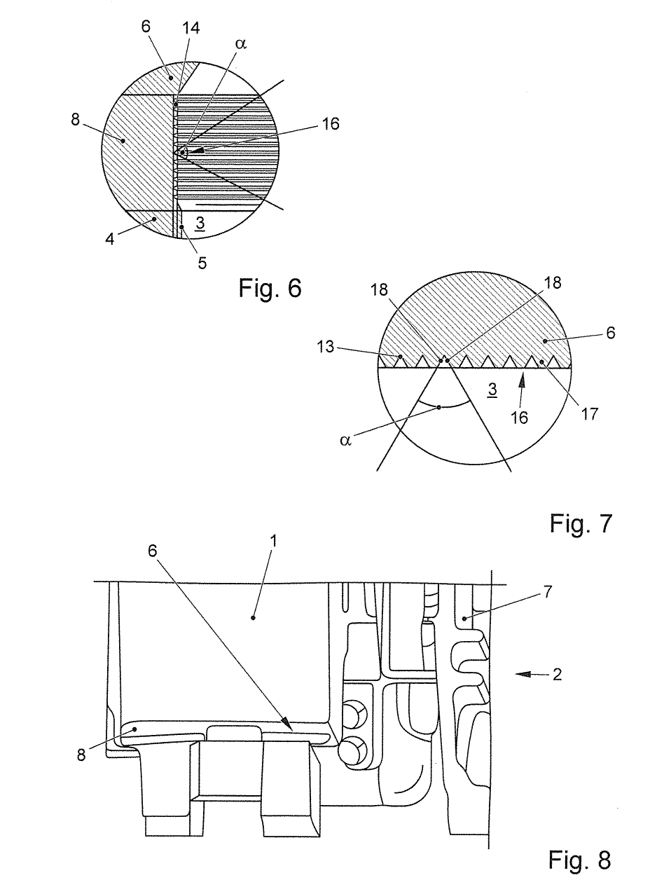

FIG. 3 shows a detailed view III of the cylinder 1 according to the invention. The defined structure 16 is configured in the form of a tooth-shaped structure. There is an angle α between two adjacent teeth 17 of the defined structure 16 at their side surfaces 18 which are configured so as to face one another, which angle α has a value of between 30° and 60°, as shown in FIGS. 6 and 7, in particular.

The defined structure 16 has a constant pitch P with a value of greater than or equal to 1. In the present exemplary embodiment, it has been produced in a spindle process. It might likewise also be configured in a circular machining operation or a helical machining operation.

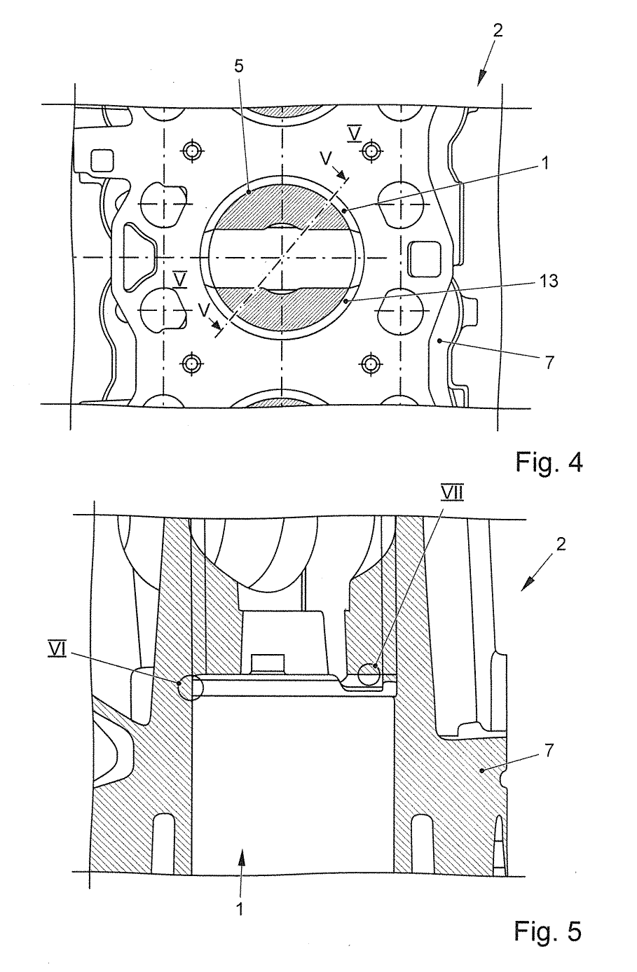

FIG. 4 shows a plan view of the crankcase 7 with the cylinder 1 according to the invention. The cylinder 1 according to the invention is shown in a section along a sectional line V-V in details in the region of the defined structure 16 in FIG. 5 and in a perspective view in FIG. 8. The positions of the detailed views VI (see FIG. 6) and VII (see FIG. 7) of the defined structure 16 can be gathered from FIG. 5.

What is claimed is:

1. A method for coating a cylinder of an internal combustion engine, the cylinder being in a crankcase of the internal combustion engine and having a cylinder lining surface section with a piston running surface facing an interior space of the cylinder and along which a piston of the internal combustion engine can be moved, and the cylinder having further surfaces that adjoin the interior space, the method comprising:
forming a defined structure at the further surface; and then
spraying a coating on the piston running surface in a second step.

2. The method of claim 1, wherein the coating is a plasma coating.

3. The method of claim 2, further comprising extracting reflected particles of the coating after spraying the coating or simultaneously with the spraying of the coating.

4. The method of claim 3, further comprising removing the defined structure after the spraying of the coating.

5. The method of claim 4, wherein the removing of the defined structure comprises removing the coating from the further surface.

6. The method of claim 5, wherein, after extracting the reflected particles the method further comprises removing the coating that had been applied on the further surface.

7. The method of claim 1, wherein the forming of the defined structure is carried out as part of a spindle process, a circular machining operation or a helical machining operation.

8. The method of claim 1, wherein the forming of the defined structure comprises forming a tooth-shaped structure.

9. The method of claim 8, the forming of the tooth-shaped structure comprises forming an angle (α) of between 30° and 60° between two adjacent teeth of the tooth-shaped structure.

10. The method of claim 8, wherein the defined structure is configured with a pitch having a value of greater than or equal to 1.

11. A cylinder for an internal combustion engine, the cylinder having a cylinder lining surface section with a piston running surface facing an interior space of the cylinder and along which a piston of the internal combustion engine can be moved, and the cylinder having further surfaces that adjoin the interior space, the further surfaces including a bearing section surface configured for mounting a crankshaft of the internal combustion engine, and a run-out section surface between the bearing section and the cylinder lining surface section, wherein the cylinder has a defined structure at least temporarily.

12. The cylinder of claim 11, wherein the defined structure is on at least part of the further surface facing the interior space.

13. The cylinder of claim 12, wherein the defined structure is tooth-shaped.

14. The cylinder of claim 13, wherein an angle (α) of between 30° and 60° is configured between two adjacent teeth of the defined structure.

15. The cylinder of claim 13, wherein the defined structure has a pitch greater than or equal to 1.
